(19) United States
(12) Patent Application Publication
(10) Pub. No.: US 2020/0043065 A1
(43) Pub. Date: Feb. 6, 2020

(54) Service Based Certificate

(71) Applicant: Robert Gelfond, New York, NY (US)

(72) Inventor: Robert Gelfond, New York, NY (US)

(21) Appl. No.: 16/510,470

(22) Filed: Jul. 12, 2019

Related U.S. Application Data
(63) Continuation of application No. 13/623,704, filed on Sep. 20, 2012.

(51) Int. Cl. G06Q 30/06

(52) U.S. Cl. CPC G06Q 30/06

(57) ABSTRACT

A claim on service or service based certificate (SBC) is a new form of currency. The SBC is non-fiat and not tied to a commodity. Rather, SBCs are valued in relation to a value-added resource that grows with economic advancement or other increases in technology. In exemplary embodiments, the SBC is valued with regard to computing power and, as such, increases, decreases or is otherwise altered in value with advancements in computing power. Over any given period of time, the value of an SBC may increase, decrease or remain steady based on advancements in computing power or changes in related financial or economic conditions.

### RELATED APPLICATIONS

This application is a continuation application of U.S. patent application Ser. No. 13/623,704 titled “SERVICE BASED CERTIFICATE” and filed Sep. 20, 2012. The '704 application is hereby incorporated by reference.

### BACKGROUND OF THE INVENTION

### Field of the Invention

This invention is related to a system, method, and apparatus usable for allocating resources. More specifically, this application is related to a system, method, and apparatus usable for allocating resources based on a service based certificate.

### Related Art

U.S. Pat. No. 5,797,127 purports to disclose an apparatus, method, and program for determining a price of an option to purchase an airline ticket and for facilitating the sale and exercise of those options. By purchasing an option, a customer can lock in a specified airfare without tying up his money and without risking the loss of the ticket price if his travel plans change. Pricing of the options may be based on departure location criteria, destination location criteria, and travel criteria.

U.S. Pat. No. 6,035,289 purports to disclose a computer-implemented method for double auction trade-building by matching, based on feasibility and price/cost heuristics, a plurality of electronically posted bids with a plurality of electronically posted ask records. A one-pass sequential trade building method selects ask records one at a time and sequentially inserts, in one pass, as many of the bid records as possible while maintaining feasibility criteria. A two pass sequential trade-building method inserts the bid records in two stages, the first terminating when the trade becomes feasible and the second when no further bids can be inserted.

U.S. Pat. No. 6,144,948 purports to disclose a system and method that uses customer information collected by a sponsoring organization, such as a hotel, to request and pre-approve a line of credit for a customer with an issuing bank prior to the anticipated arrival of the customer at the facilities of the sponsoring organization. In one embodiment, the anticipated arrival of a potential customer is identified when the customer makes a reservation for future services or registers for attendance at a future event. Preferably, the credit card is instantly issued to the customer and activated by the sponsoring organization on behalf of the customer as part of a chargeable event while the customer is at the facilities of the sponsoring organization. The sponsoring organization may opt to offer the issuing bank a guarantee of coverage over the line of credit extended by the issuing bank. Also, customers may choose the incentive benefits they wish to receive from using the line of credit.

U.S. Pat. No. 7,373,320 purports to disclose a futures exchange for services contracts. The SerFex is an electronic market system that enables the exchange of cash (spot and forward) contracts and futures contracts for the delivery of services. Services are traded on the exchange similar to commodities on a prior art commodities exchange. The exchange allows the futures market to determine the right price for services for the producers and consumers of those services. Participants may buy, sell, or leverage services contracts through a variety of order types. The exchange is composed of an electronic infrastructure that has four major components: a front-end facility comprised of licensed authorized intermediaries, an automated bid/ask matching system, a clearinghouse system, and a title management system. The exchange operates twenty-four hours per day and seven days per week with all accounts settled at least once in every twenty-four hours. Participants in the exchange may be producers of services, intermediaries, speculators, and consumers of the services.

U.S. Pat. No. 7,440,926 purports to disclose a system and method for providing a present consideration to a consumer and coincidentally establishing a future right for a holder to offer or to provide, at the holder's option a defined set of goods or services in response to a trigger event.

U.S. Patent Application Publication Number 2001/0034687 purports to disclose market liquidity for service-based commodities established by fixing contract maturity dates and directing spot market trades to these fixed dates. Service contracts have the following characteristics: a specific duration during which the service is to be provided, a specific service quality, a specific service delivery date, a specific service maturity date and a specific delivery location. The contract maturity dates are consistent with forward contract delivery dates, preferably, monthly or quarterly. Unlike a traditional goods-based futures contract, each forward contract, after delivery, does not stop trading but continues to trade on spot markets until maturity. Market information for each type of service contract is provided to users of an exchange system, preferably implemented within a publicly available network, such as the Internet or World Wide Web. Based on this market information, users may submit quote proposals (e.g., bid or offers) or quote acceptances.

U.S. Patent Application Publication Number 2008/0109233 purports to disclose an integrated rights marketplace screening individuals by one or more criterion, wherein the screening pre-qualifies an individual, and provide pre-qualified individuals with the ability to acquire a contingent right.

U.S. Patent Application Publication Number 2009/0307046 purports to disclose an electronic contracting method and apparatus for the purchase of pre-funded future services to equalize the bargaining positions of the parties and then deliver payment in accordance with the negotiated service contract terms.

### SUMMARY OF THE INVENTION

The above prior art, including U.S. Pat. Nos. 5,797,127; 6,035,289; 6,144,948; 4,373,320 and 7,440,926, and U.S. Patent Application Publication Nos.: 2001/0034687; 2008/0109233; and 2009/0307046, is incorporated herein by reference and forms a part of this disclosure.

Desirably, a viable type of money should satisfy 3 conditions:
1—a store of value
2—a stable unit of account
3—liquid enough to be used in any sort of economic or financial transaction

To date, monies are, or historically have been, either backed by a commodity like gold (e.g., redeemable on demand into a fixed amount of the commodity backing them) or fiat, not redeemable explicitly into anything and backed by a government's monopoly central bank. Some currencies are explicitly backed by other fiat currencies but this still makes them fiat (e.g., the Hong Kong Dollar is tied to the US Dollar which is fiat). Quasi-currencies can be similarly defined or categorized. For example, currencies developed in online games may have a real world value, in that they can be sold for dollars, but there's no explicit backing for them so they should be categorized as fiat. Similarly, credit card point schemes are convertible into dollars or certain types of merchandise or services but with restrictions on availability.

Airline miles (and similarly for other frequent user programs) cannot be easily transferred between parties and are therefore not liquid enough to be considered a true currency. They are often only convertible into a single defined item, such as, for example, airline seats, but the conversion may come with many restrictions. Further, these types of quasi-currencies often expire and become worthless if not used by a certain time limit. Furthermore the conversion rate of, for example, miles needed for to exchange for a seat, often varies over time giving the miles an intangible value.

Historically, fiat money loses value over time in the form of inflation. Meanwhile, the value of commodity money can be unstable due to differences in the ability to create or discover the commodity and technological progress in the rest of the economy. As economies become more diversified and developed, and less reliant on commodities these differences can become greater, leading to greater instability (both going up and down in value) of commodity money. Linking a currency to a basket of commodities does not solve this problem as historically, over long periods of time, the value of commodities in real terms declines due at least in part to technological advances in the ability to create and/or find and extract commodities. Additionally economic growth means that, for example, more oil is used today than 30 years ago; even though, as a percentage of economic activity, its usage has gone down over that same period.

In an exemplary embodiment in accordance with the present invention, a claim on service or Service Based Certificate (“SBC”) is a non-money product that is more stable than money as it currently exists. Exemplary embodiments of a claim on service or SBC are backed by a resource that grows with the overall economy even as the economy changes in nature. Examples of such resources, but not limited thereto, are electricity or computing. Both are value added products/services derived from technology. If airlines were to sell seats that were fully transferable and didn't expire they would also represent a potential resource to base a currency on, although one much less ubiquitous than electricity or computing.

Banks that produced commodity or fiat money, profit from seigniorage, the bank notes they produce pay no interest while they can earn interest on the asset exchanged for the bank note. In the case of commodities, this interest comes from loaning out the commodity. For fiat money, the interest is earned in buying interest bearing, low risk assets.

Producers of exemplary embodiments of claims on service or SBCs would, in various exemplary embodiments, already be profiting for the service they were providing. Additionally, in various exemplary embodiments, a producer may provide the service at a discount or reduced price (e.g., as a loss leader) to attract users to the service and the producers of claims on service or SBCs. In some such exemplary embodiments, the producers may take an initial loss on the service while making a profit on the users' purchases of the claims on service or SBCs. Exemplary embodiments of claims on service or SBCs would allow producers to achieve a lower cost of capital so that, unlike producers of traditional money, they wouldn't need to profit from seignoriage.

In an exemplary embodiment of a system, utilizing exemplary embodiments of claims on service or SBCs, the system includes a computing device, an interface (such as, for example, an input/output interface) and a display. In various exemplary embodiments, the computing device maintains an exchange database and a certificate database. In such exemplary embodiments, the exchange database maintains, stores or provides an exchange rate usable to convert a claim on service or SBC into other goods, services or currency. For example the exchange database may include an exchange rate for converting a claim on service or SBC into a resource used to back the claim on service or SBC. Likewise, in other exemplary embodiments, the exchange rate may be usable to convert the claim on service or SBC into currency.

In various exemplary embodiments of systems utilizing exemplary embodiments of claims on service or SBCs, the system includes a certificate database that is usable to store, maintain, or track information related to specific claims on service or SBCs issued by a producer. For example, in various exemplary embodiments, the certificate database includes logs of serial numbers assigned to each claim on service or SBC. The certificate database may also include information related to the date of purchase, date of exchange, present value, or any other information related to the claim on service or SBC that is desirably tracked. In various exemplary embodiments, the certificate database includes information related to the owner or rightful holder of a claim on service or SBC. In other exemplary embodiments, the ownership of a claim on service or SBC may be intentionally left anonymous.

It should be appreciated that the exchange database and certificate database need not be maintained in traditional database formats. Rather, in various exemplary embodiments, the exchange database and the certificate database may be stored in any matter usable to store, log, maintain, catalog or the like, the information desirable to be tracked. Similarly, in various exemplary embodiments, the exchange database and the certificate database may be the same database or separate parts of a single database with each part being dedicated to the particular function. It should also be appreciated that in various exemplary embodiments, either or both of the exchange database and certificate database may be omitted or replaced with a suitable form of calculating the desired information. For example, in various exemplary embodiments, rather than an exchange database that stores an exchange rate, the system may include pricing information or references to pricing information that can be used to instantaneously calculate an exchange rate rather than, for example, continuously maintaining the exchange rate.

It should be appreciated that in the following description, for the ease of explanation, computing is used as an example of a resource for backing an exemplary embodiment of a claim on service or SBC. It should also be appreciated that other resources could be used as an alternative to or in addition to the use of computing. For example, various exemplary embodiments may use electricity.

It should be appreciated that one resource may be more desirable than another resource due, at least in part, to its ability to satisfy one of the above-outlined qualities of money. For example, in various exemplary embodiments, computing power may be a more desirable resource than electricity because it is more fungible. In various exemplary embodiments other factors may affect the viability of a resource to function as a backing for a claim on service or SBC. For example, government regulation over the production, transport, use, sale or the like of a resource may make it less liquid, less fungible or otherwise less desirable as a suitable resource. In various exemplary embodiments, computing power is a more desirable resource to function as the backing of a claim on service or SBC when compared to electricity because the regulation of utility companies and the production of energy from raw resources results in vast discrepancy in the price of electricity from one location to another. As such, the government regulation makes electricity less fungible in comparison to computing power,

Computing is a useful example in part because it has become a vital part of virtually every industry. Computing can be defined as the manipulation of information based on certain instructions. Computing is a physical process but is not a commodity. Rather, computing is derived from the application of technology to commodities. Its capabilities change as technology progresses in both hardware and software. However, it should be appreciated that other resources may be used and may or may not share some or all of these qualities with computing.

### BRIEF DESCRIPTION OF THE DRAWINGS

Various exemplary embodiments of the systems and methods according to this invention will be described in detail, with reference to the following figures, wherein:

FIG. 1 is a schematic representation of a system for utilizing service based certificates according to an exemplary embodiment; and

FIG. 2 is a schematic representation of an exemplary embodiment of a system usable with an exemplary embodiment of a service based certificate.

### DETAILED DESCRIPTION OF EXEMPLARY EMBODIMENTS

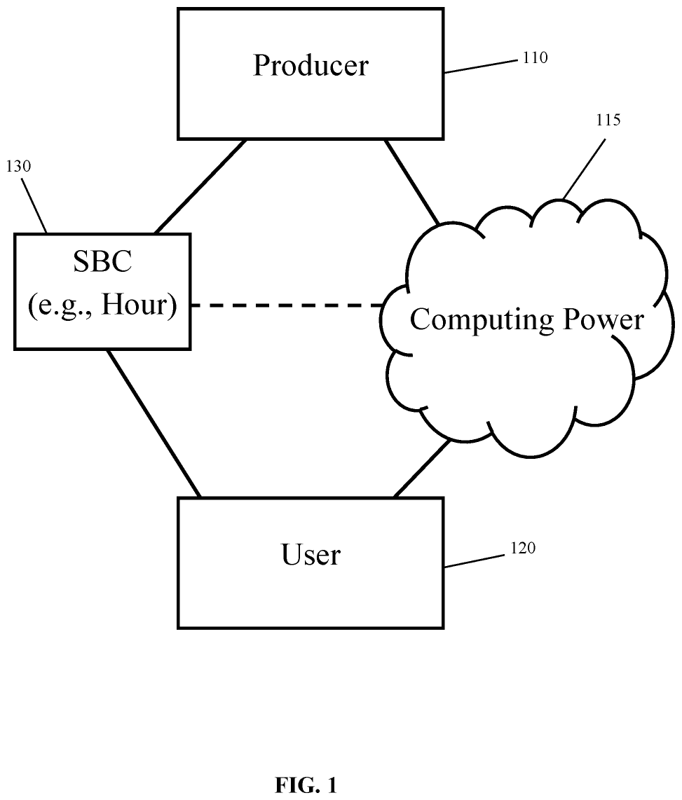

As shown in FIG. 1, an exemplary embodiment of a system for utilizing service based certificates includes a provider 110. In various exemplary embodiments, the producer 110 leases computing power 115 to users 120. It should be appreciated that the computing power 115 can be regulated in any desirable manner. For example, in various exemplary embodiments, computing power is measured in computing time. In various other exemplary embodiments, computing power is measured via one or more computing resource.

In various exemplary embodiments, in addition to, or as an alternative to, leasing computing power 115, the users 120 can buy claims on service or service based certificates (SBCs) 130 for future use on the a computing system. In various exemplary embodiments, a producer, such as the producer 110 or any other producer or lessor of computing power, can offer these SBCs 130 for use on a cloud or in-person system. Additionally, because the SBCs have a value, they may be purchased or obtained as a means to store value or as a potential investment. For example, because the SBCs are liquid, a user may purchase an SBC intending to sell it to another user at a later date.

It should be appreciated that exemplary embodiments of SBCs 130 can be defined by any unit of use. For example, in various exemplary embodiments, an “Hour” is defined as an hour of computer usage on a base or standardized computer. In such exemplary embodiments, usage of non-standard computers (e.g. more or less powerful computers) can be defined as a factor or fraction of Hours on the standardized model. Similarly other services like memory or hard drive storage can be defined as a factor of these standard Hours or as a separately rationed resource. In various exemplary embodiments, the factors between standard Hours and time on non-standard computers or the relationship between Hours and other computing resources may fluctuate. That is, the ratios need not be fixed and may move around based on market conditions. For example, there is no current fixed ratio of the price between different levels of computing services.

Satisfying Condition 1:

In various exemplary embodiments, the standard measure of resources backing the SBCs 130 will change over time, such as, for example as computer processing power increases. In the exemplary embodiment shown in FIG. 1, the value of the SBC 130, such as an Hour is maintained and doesn't degrade over time. That is, in various exemplary embodiments, a user 120 who buys an SBC 130, such as an Hour, and then does not redeem or spend the SBC for two years will receive the standard value of the SBC, such as an hour of computing time on a standardized computer, at the time of redemption not the standard at the time of purchase. Computing is now an essential part of almost all economic activity, the increase in the capacity and power of computers is also highly correlated to economic growth. Giving the provider of computing resources incentives to increase both the capacity and quality of their resources for which the SBC's 130 or claims (e.g., the Hours of computing time) are being issued against.

It should be appreciated that provider who issued, for example, Hours without increasing the capacity or quality of their resources would face a falling price of Hours. That is, users would be discouraged from purchasing SBCs from the producer and the producer would be forced to lower its price to compete. This relationship can be viewed as being analogous to inflation in fiat currencies. Since, in various exemplary embodiments, the provider is already selling computing services in a competitive environment, this alone will compel the provider to keep their resources up to date and as reliable as possible.

Satisfying Condition 2:

In various exemplary embodiments, once issued, SBCs 130, such as Hours, would never expire. In such exemplary embodiments, the SBCs could be redeemed at any point in the future. Thus, the exemplary Hours would be fungible. Similarly, the exemplary Hours are easily divided into smaller units, which can in turn be spent/redeemed or transferred.

Satisfying Condition 3:

In various exemplary embodiments, to maximize liquidity the provider 110 allows SBCs 130, such as Hours, to be fully transferable between any parties without permission of the provider 110. In one such exemplary embodiment, Hours can be transferred from a first person or entity to a second person or entity by an electronic transfer, such as through the provider's website, tablet application or special purpose device like an ATM; or through a physical transfer using for example, a smart card issued by the provider or a physically produced certificate that can be hard to counterfeit like a gift certificate or bank note. All these methods of transferring SBCs can be viewed as analogous to how banks allow for transferring of cash or deposits from one person or entity to another.

It should be appreciated that, in various exemplary embodiments, a chosen form of physical transfer may also allow for anonymity of SBC owners from the provider, which may add utility or value to the SBC. In various exemplary embodiments, anonymity for electronic transfers can be facilitated by the provider setting up clearinghouses and/or bank-like entities that can handle transfers internally between various people or entities without reporting to the provider. These clearinghouses or bank-like entities need not be owned by the provider but, in various exemplary embodiments, the clearinghouses or bank-like entities may have a contractual relationship that establishes a level of anonymity, or the lack thereof, between the SBC owners and the producer. It should be appreciated that, in various exemplary embodiments, there may be a cost associated with providing anonymity and that some consumers might willingly forego anonymity to garner a lower price.

In various exemplary embodiments, if a particular type of SBC, such as Hours, becomes sufficiently popular, the clearinghouses or bank-like entities may, with the permission of the provider and/or based on certain rules stipulated by the provider, create loans denominated in Hours and pay interest in Hour deposits to the entities. As such, in various exemplary embodiments, the handling of Hours may be viewed as an analog to a traditional banking system. However, in contrast to those traditional banking systems, interest is paid by increasing Hours, or some other suitable SBC, on an account by some percentage and not by paying the holder dollars.

In various exemplary embodiments, further utility for SBCs, such as Hours, can be created if the provider pays interest on Hours on deposit. This method may be desirable as an additional means to deal with peak pricing. For example, in various exemplary embodiments, during peak demand, the provider may pay higher interest on Hours left on deposit rather than being redeemed to incentivize holders not to redeem at these peak times. Unlike bank deposits on cash, interest rates on SBCs, such as Hours, can be adjusted every minute, every hour, or, on any other desired period of time and need not be held static for an entire day, or any other period of time.

In various exemplary embodiments, if the productivity of cloud computing is not increasing as fast as the overall economy, therefor causing the value of the Hour to fall relative to other products and services, the provider can increase interest rates paid on Hours to help ensure that hours maintained their real (inflation adjusted) value. Similarly, a producer can take like action against the falling relative value of SBCs based on any other resource.

Further, one or more producers may purchase SBCs on the open market to reduce their supply. In various exemplary embodiments, a producer may purchase SBCs on the open market in an attempt to increase, stabilize, or otherwise affect the value or price of the SBCs.

In various exemplary embodiments issuing SBCs, such as Hours, provides a novel way to finance the provider's capital expenditures. In such exemplary embodiments, instead of getting a loan or selling equity, the provider may increase interest rates on Hours to a point sufficient enough to attract consumers to forego redeeming the SBCs at that time and/or for a desired time period. Additionally, these efforts may incentivize users or investors to purchase SBCs they might not otherwise purchase. In this way, the increase in Hours can be viewed as an analog to a liability issued against the asset(s) bought. That it, in return for the asset, the producer has taken on a liability to back a larger number of SBCs.

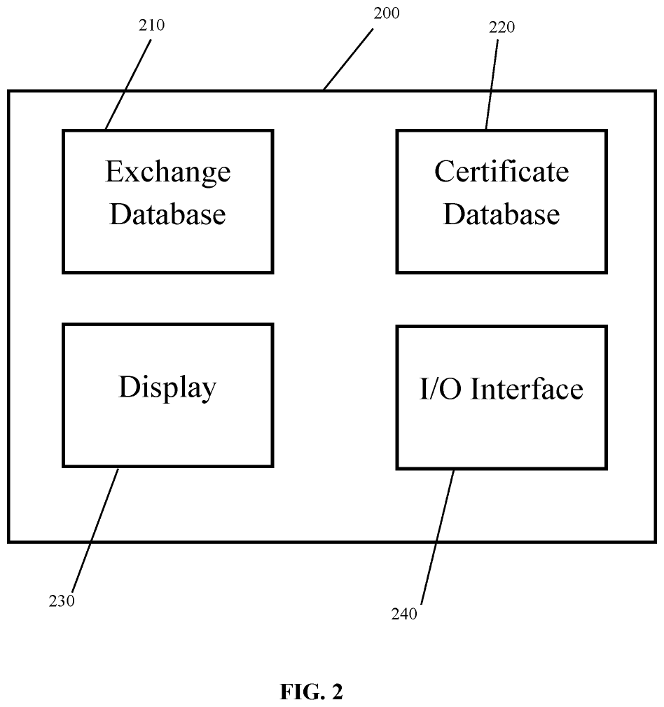

FIG. 2 shows an exemplary embodiment of a system 200 usable with an exemplary embodiment of an SBC. As shown in FIG. 2, the system 200 includes an exchange database 210 and a certificate database 220. In various exemplary embodiments, the exchange database 210 and the certificate database 220 are stored on, maintained on, or elements of a computing device, such as, for example, a server.

The exchange database 210 is usable to store, maintain, calculate or track information related to an exchange rate of the SBCs. For example, the exchange database 210 may store a current and/or historical exchange rate usable to convert the SBC into another good, service, commodity, currency or the like. In various exemplary embodiments, the exchange database 210 may store an exchange rate usable to convert the SBC into, the resource, such as, for example, computing power, used to back the SBC. In various exemplary embodiments, some or all of the information stored in the exchange database 210 may be updated on a regular basis such as, for example, yearly, quarterly, monthly, weekly, daily, hourly, or continuously.

The certificate database 220 is usable to store, maintain, calculate or track information related to the individual SBC issued by one or more producers. For example, the certificate database 220 may include a list of valid serial numbers, hash functions, checksums, check digits, digital fingerprints, or the like usable to authenticate the SBCs. In various exemplary embodiments, the certificate database 220 may also include information related to the history of the SBC such as, for example, the production date, the first sale date, the sale history, the last sale date, the historic value or exchange rate, the past or current owners or valid holders of the SBC, or the like. In various exemplary embodiments, the certificate database 220 include information usable to authenticate a holder or user of an SBC as a valid or authorize holder or user of the SBC.

It should be appreciated that the exchange database 210 and the certificate database 220 may be the same database, elements of the same database, dedicated portions of one or more databases, or the like. Additionally, in various exemplary embodiments, the exchange database 210 and/or the certificate database 220 are usable to track the total number of SBCs issued by one or more producers. In various exemplary embodiments, tracking the total number of outstanding SBCs is desirable in order to track, maintain, or monitor an outstanding liability to exchange the SBCs. Likewise, in various exemplary embodiments, the exchange database 210 and/or the certificate database 220 may be usable to track historic numbers of issued, exchanged, and/or outstanding SBCs.

In various exemplary embodiments the system 200 also includes a display 230 usable to display information, such as the information stored in the exchange database 210 and/or the certificate database 220, to a user. It should be appreciated that the display may be a local display or may be a separate display in communication with the system 200. In various exemplary embodiments, the display 230 is usable to show an exchange rate of the SBCs and any updated exchange rate.

In various exemplary embodiments, the system 200 includes an input/output interface 240 usable to enter, retrieve, update or otherwise interact with information stored by, maintained by, or otherwise accessible to the system. For example, in various exemplary embodiments, the system includes a human interface device usable to process, authenticate, verify, or otherwise interact with the SBCs.

In various exemplary embodiments, a user can utilize the system 200 to determine the current, or past exchange rate of an SBC. In various ones of these exemplary embodiments, the user enters information to identify the SBC, such as, for example, keying in a serial number, scanning a bar code, passing the SBC into a reader or scanner. In various exemplary embodiments, the information is entered through the input/output interface 240. The system may then compare the information such as, for example, the serial number, barcode, or information gathered from the reader or scanner to compare to information stored in the certificate database 220 to authenticate or verify the SBC. Once authenticated or verified, the system may compare the SBC to an exchange rate or exchange information stored in the exchange database 210 to determine or calculate a value of the SBC. For example, in various exemplary embodiments, the SBC is converted into an allowance of computing time, an amount of currency, another SBC, or the like. In various exemplary embodiments, the exchange rate, value of the SBC, exchange information, certificate information or other information related to the SBC is then display on the display 230

It should be appreciated that, while the above-outlined exemplary embodiments discuss “purchasing” and “selling” SBCs, the exchange may occur through any known or later developed economic or financial transaction. For example, a user may obtain SBCs in return for goods or services or may purchase SBCs with an existing form of currency. Likewise, SBCs may be exchanged for anything else of value, given as interest for SBCs held on account, offered as a reward (such as, for example, through a loyalty program), or as a bonus or rebate to encourage the purchase of other goods or services.

Likewise in various exemplary embodiments, as with other forms of currency, commodities, and the like, secondary exchanges may be provided wherein an investor may purchase futures, options, bonds or other interests in the current or future value of SBCs.

What is claimed is:

1. A method for allocating resources comprising the steps of:
creating service based certificates to be sold;
storing the service based certificates on a database;
associating the service based certificates with an available resource;
selling the service based certificates to end users to attain purchased service based certificates;
maintaining an exchange rate for exchanging the service based certificates for the resource;
locking in an enforceable exchange rate for each purchased service based certificate at a time of sale; and
updating the maintained exchange rate in response to changes in the availability of the resource over time.

2. The method of claim 1, wherein the available resource is computing power.

3. The method of claim 2, wherein the computing power is measured in hours of usage on a standardized computer.

4. A service based certificate system comprising:
a first source for creating service based certificates wherein the service based certificates have a changing value based on the availability of a computer resource;
a first storage medium for electronically storing the service based certificates created by the first source;
a second source for acquiring service based certificates at a known value from the first source to create acquired service based certificates;
a second storage medium for electronically storing the acquired service based certificates, wherein the acquired service based certificates are economic notes that are valued in relation to the computer resource that increases over time as a function of perceived improvements made in computer technology; and
a processor for calculating the changing value of the service based certificates based on the availability of the computer resource at a given time.

5. The service based certificate system of claim 4, wherein the economic notes are digital currency.

6. The service based certificate system of claim 4, wherein the economic notes are a form of commercial paper.

7. The service based certificate system of claim 4, wherein the economic notes are negotiable instruments.

8. The service based certificate system of claim 4, wherein the resource is computing power.

9. The service based certificate system of claim 4, wherein the economic notes are redeemable for a measurable quantity of the resource.

10. The service based certificate system of claim 9, wherein the measurable quantity of the resource fluctuates Aver time.

11. A method for allocating a resource comprising the steps of:
creating service based certificates to be sold;
associating the service based certificates with an available resource;
storing in a database the service based certificates associated with the available resource;
selling the service based certificates to end users to achieve purchased service based certificates and noting the sales in the database;
maintaining an exchange rate for exchanging the purchased service based certificates for the available resource;
locking in an enforceable exchange rate for each of the purchased service based certificates at a time of sale;
updating the exchange rate in response to changes in the availability of the resource over time; and
displaying the updated exchange rate on a display.

12. The method of claim 11, wherein the available resource is computing power.

13. The method of claim 12, wherein the computing power is measured in hours of usage on a standardized computer.

14. A service based certificate system comprising:
a source for creating service based certificates wherein each of the service based certificates has a value based on availability of a computer resource;
storage medium for electronically storing the service based certificates created;
a source for purchasing service based certificates at a known value to create purchased service based certificates;
storage medium for electronically storing purchased service based certificates, wherein each purchased service based certificate is an electronically stored economic note that is valued in relation to the computer resource which increases over time as a function of perceived improvements made in computer technology; and
a processor for calculating the changing value of service based certificates based on the availability of the computer resource at a given time.

15. The service based certificate system of claim 14, wherein the economic note is a digital currency.

16. The service based certificate system of claim 14, wherein the economic note is a form of commercial paper.

17. The service based certificate system of claim 14, wherein the economic note is negotiable instrument.

18. The service based certificate system of claim 14, wherein the resource is computing power.

19. The service based certificate system of claim 14, wherein the economic note is redeemable for a measurable quantity of the resource.

20. The service based certificate system of claim 19, wherein the measurable quantity of the resource fluctuates over time.
